(19) United States
(12) Patent Application Publication
(10) Pub. No.: US 2024/0105076 A1
(43) Pub. Date: Mar. 28, 2024

(54) DEVICE AND METHOD FOR EVALUATING SKILLS

(71) Applicant: THALES, COURBEVOIE (FR)

(72) Inventors: Pascal PEYRONNET, MERIGNAC (FR); Guillaume PABIA, MERIGNAC (FR)

(21) Appl. No.: 18/276,032

(22) PCT Filed: Feb. 7, 2022
(86) PCT No.: PCT/EP2022/052860

§ 371 Date: Aug. 6, 2023

(30) Foreign Application Priority Data
Feb. 9, 2021 (FR) 2101200

(51) Int. Cl. G09B 9/08; G09B 19/16

(52) U.S. Cl. CPC G09B 9/08; G09B 19/165

(57) ABSTRACT

A method for assessing technical and non-technical skills of an operator, includes a step of collecting endogenous data relating to physical manifestations of the operator, and exogenous data relating to the context of a session; steps, implemented by data processing modules, of: correlating the collected data in order to link endogenous data to exogenous data; detecting, using the correlated data, observable behavior data comprising at least one trigger event parameter and one action parameter; analyzing the observable behavior data in predefined analysis sequences, each predefined analysis sequence being specific to a skill to be assessed, and comprising a trigger event parameter and an action parameter characterizing an expected observable behavior according to a predefined situation, the analysis generating a measurement indicator; assessing the behaviors of the operator, by comparing an observed behavior with an expected reference behavior; assessing each skill of the operator on the basis of the results of the behavior assessments.

### CROSS-REFERENCE TO RELATED APPLICATIONS

This application is a National Stage of International patent application PCT/EP2022/052860, filed on Feb. 7, 2022, which claims priority to foreign French patent application No. FR 2101200, filed on Feb. 9, 2021, the disclosures of which are incorporated by reference in their entireties.

### FIELD OF THE INVENTION

The invention proposes a device and a method for precisely and succinctly assessing the skills of an operator or of a team of operators in a training situation or in a real or simulated mission situation. The field of application of the invention may concern all fields implementing complex systems managed by operators or a team of operators, having to apply procedures, make decisions according to situations, communicate and interact with systems and with other operators, and for which safety is paramount. More specifically, the invention relates to the field of assessing the flying skills of a pilot and/or of a crew in a simulation or training situation on a dedicated platform.

These fields concern, without being exhaustive:
The field of transport, such as for example the aeronautical sector, the railway sector, the maritime sector or the automotive sector,
The field of situation management, such as for example the air traffic control sector, the public safety sector,
The field of industrial process management, such as for example the energy production sector.

### BACKGROUND

Document FR 3 098 389 from the Applicant proposes a method for analyzing the behavior of an operator in a simulation or training situation, allowing an observer to obtain statistical data that provide real-time information about the state and the behavior of the operator. Using these statistical data, the observer is able to carry out their own analysis of the technical and non-technical skills of the operator. Nevertheless, in this approach, the analysis is based largely on the subjectivity and partiality of the observer. The data obtained for one and the same operator may thus lead to a different analysis of their skills, depending on the observer who carries out the analysis.

Evidence-based training (EBT) is a method for assessing and training commercial aviation pilots developed by players in the aeronautical world, based on an objective skills assessment (competency-based training).

Pilots are thus assessed according to a set of nine technical and non-technical skills, namely application of procedures, communication, flight path management (manual and automated), knowledge, leadership and teamwork, problem solving and decision making, situational awareness and lastly workload management.

In order to assist instructors in assessing these non-technical skills, the European Union Aviation Safety Agency (EASA) has published a list of Observable Behavior Indicators (OBI). These behavior indicators make it possible to objectify these various skills and provide a shared assessment framework between instructors, enabling a reduction in subjectivity in the assessment.

However, these OBI may also be subject to varying interpretations among instructors and may be difficult to detect owing to the large number thereof or the variety thereof. Indeed, a training or simulation session generally lasts between three and four hours, which constitutes a challenging time both for the pilot, who is playing for the validity of his license, and for the instructor in charge of the simulation. Thus, during these sessions, many faults and situations are studied by the pilot or the crew under the tutelage of the instructor. Said instructor is therefore at the heart of the training device and has to deal with many tasks such as the management and execution of the scenario, the smooth running of the scenario, the simulation of air traffic control interactions, and cabin crew interactions.

In addition to this, the introduction of evidence-based training requires the instructor also to monitor the pilot and their team in order to detect the observable behavior (OB) data needed for the skills assessment.

However, the instructor is poorly equipped and very often uses only annotations of events that they have observed during the session, and the detection of the many OBs, represented by ten or so indicators for each skill, is therefore very often partial.

In summary, instructors are therefore responsible for the real-time assessment of pilots as well as the management of the simulation and the organization of the training session. Limited by positioning that is behind the crew and that is not conducive to observation, and by non-existent or still underdeveloped tools, these observation tasks are difficult to carry out and the workload of instructors is greatly increased. Mentally overloaded and/or constrained by the activities necessary for the session to run smoothly, instructors are not able to detect all the behavior indicators (OB) needed for the correct assessment of pilots.

These flaws may subsequently introduce gaps in the assessment and the work on the skills of pilots, who could in turn jeopardize the safety of flight operations.

Some solutions for overcoming the abovementioned limitations have been developed, such as video surveillance of the pilot and their team during a training situation, allowing the instructor to obtain a means of viewing from a viewpoint different from their own or else a means of observing technical skills (management of brakes, control stick, flaps) showcased by the pilot and their team. However, no method for objectifying non-technical skills has been developed to date. In addition, instructor assistance systems are generally not linked to evidence-based training skills and the information provided to the instructor does not generally allow the instructor to be easily directed to observable behavior data needed to assess skills. Ultimately, this burden falls on the instructor, who then also has to analyze the videos that are obtained or the data that are captured in order to correlate them with possible observable behavior data allowing a skill to be assessed. A few studies, such as for example U.S. Ser. No. 10/755,591, already mention these skills, but do not provide a significant solution to this problem.

However, as mentioned above, the large amount of detectable observable behavior data combined with the need to study assistive media in order to be able to assess non-technical skills, for which the systems developed to date do not offer a solution, always partially increase the workload of the instructor without otherwise assisting them with their assessment.

### SUMMARY OF THE INVENTION

The invention aims to overcome all or some of the abovementioned problems by proposing a device and a method for assessing technical and non-technical skills of an operator in a training situation on a platform comprising various elements that make it possible to:
collect contextual data related to the training situation,
collect data related to the pilot and/or to their team during the training situation,
analyze the abovementioned data in order to detect observable behavior data during the training situation,
assess operator behavior,
assess at least one technical and/or non-technical skill of the operator.

To this end, one subject of the invention is a method for assessing technical and non-technical skills of at least one operator in a mission or training situation on a real or simulated platform, the assessment method comprising:
a step of collecting endogenous data relating to physical manifestations of said at least one operator during a mission or training session, and exogenous data relating to the context of said session on a real or simulated platform;
computer-implemented steps, performed by data processing modules, of:
   correlating the collected data in order to link endogenous data to exogenous data;
   detecting observable behavior data using the correlated data, an observable behavior datum comprising at least one parameter called a trigger event parameter and one parameter called an action parameter;
   analyzing the observable behavior data in predefined analysis sequences, each predefined analysis sequence being specific to a technical and non-technical skill to be assessed, and comprising at least one trigger event parameter and one action parameter characterizing an expected observable behavior according to a predefined situation, the analysis generating a measurement indicator for each observed behavior;
   assessing the behaviors of said at least one operator, said assessment consisting in comparing an observed behavior with an expected predefined reference behavior; and
   assessing each technical and non-technical skill of said at least one operator on the basis of the results of the behavior assessments.

According to one aspect of the invention, the data collection step consists at least in capturing endogenous data of observational and/or manipulative and/or communication nature.

According to one aspect of the invention, the data correlation step consists in temporally grouping together endogenous data occurring following the acquisition of at least one exogenous datum or in grouping them together thematically on the basis of a given exogenous datum.

According to one aspect of the invention, the step of detecting observable behavior data comprises a step consisting in determining a trigger event originating from said at least one operator, said trigger event being notably the occurrence of an event at the origin of an action of said at least one operator or an exceeded time delay.

According to one aspect of the invention, the step of detecting observable behavior data comprises a step consisting in determining a trigger event originating from the real or simulated platform, said trigger event being the occurrence of an event at the origin of a change in state of the platform.

According to one aspect of the invention, the step consisting in determining a trigger event comprises a step of detecting trigger events originating from said at least one operator or from said platform, and a step of selecting at least one trigger event.

According to one aspect of the invention, the analysis step comprises a step of comparing detected observable behavior data with a predefined sequence defining the expected behavior, each predefined sequence representing at least one physical manifestation allocated to the expected behavior, the predefined sequences being contained in a correspondence database.

According to one aspect of the invention, the assessment method comprises, after the skill assessment step, a step of displaying the assessments of the technical and non-technical skills.

According to one aspect of the invention, the assessment method comprises a step of storing the endogenous data, the exogenous data, the observable behavior data and the assessment results.

Another subject of the invention is a device for assessing technical and non-technical skills of at least one operator in a training situation on a real or simulated platform, the assessment device comprising means for implementing the steps of the assessment method.

In one particular implementation for the field of avionics, the device of the invention is personalized so as to assess the technical and non-technical skills of a pilot or of a crew in a training situation on a simulation platform. To this end, the invention covers a flight simulator comprising the device of the invention.

The invention additionally relates to a computer program product, said computer program comprising code instructions for performing the steps of the method when said program is executed on a computer.

### BRIEF DESCRIPTION OF THE DRAWINGS

The invention will be better understood and other advantages will become apparent on reading the detailed description of one embodiment that is given by way of example, which description is illustrated by the figures, in which:

FIG. 1 shows a sequence of steps of the method for assessing technical and non-technical skills of at least one operator in a mission or training situation on a platform of the invention, in one embodiment;

FIG. 2 shows correlation and analysis steps of the method for assessing technical and non-technical skills of at least one operator in a mission or training situation on a platform of the invention, in one embodiment; and

FIG. 3 shows a device for assessing technical and non-technical skills of at least one operator in a mission or training situation, in one embodiment of the invention.

### DETAILED DESCRIPTION

For the sake of clarity, elements that are the same have been designated by the same references in all the figures.

In order to be able to allow this assessment of at least one operator, that is to say, for the avionics field, the assessment of a pilot only or of said pilot and their on-board team, in accordance with the nine technical and non-technical skills disclosed above, a few publications detail each of these nine skills and a certain number of observable behavior indicators that may allow an instructor in charge of the assessment to characterize the skills. By way of example, it is possible to cite the document “Manual of Evidence-Based Training” provided by ICAO (2013) or else “Evidence-Based Training Implementation Guide” from the IATA (July 2013).

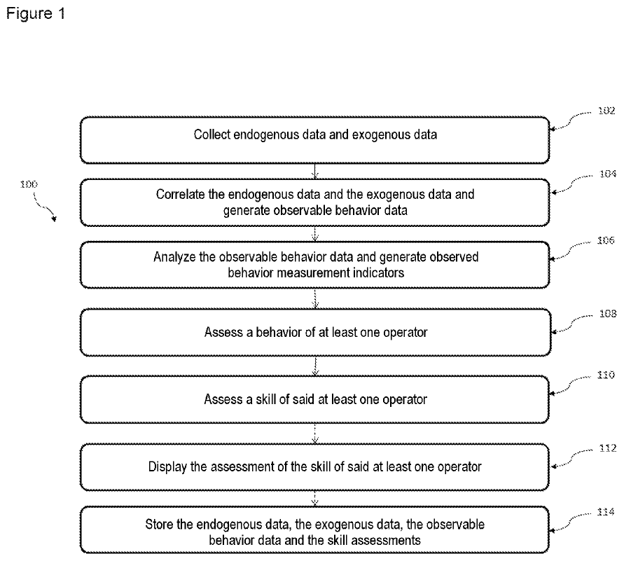

The method 100 for assessing technical and non-technical skills, shown in FIG. 1, of at least one operator in a mission or training situation on a real or simulated platform is based on these indicator descriptions.

In the present description, the term “endogenous datum” designates the physical parameters or manifestations coming from the operator, either the pilot, and/or the team of operators, or their crew. By way of example, gaze tracking or pupil tracking, detection of a particular posture, gesture recognition, analysis of communications or else of manipulative actions on a real or simulated platform may be considered to be endogenous data. The term “exogenous datum” for its part characterizes all data related to the context, such as for example avionics data coming from the platform, elements related to the scenario and the role-playing of the know-how of the operator or of the team of operators, or else the weather displayed. Overall, all of the exogenous data come from the platform. The platform also represents the cabin accommodating the operator or the team of operators. Thus, in the context of a training situation requiring a simulation of a flight situation, the platform represents the measuring device accommodating the operator or the team of operators. Conversely, in the context of a real flight situation, the platform then represents the cabin of the aircraft in which the operator or the team of operators is working.

The assessment method 100 may be implemented during a flight situation set up on a platform.

The assessment method 100, which makes it possible to develop the information necessary to assess the skills of at least one operator, may be broken down into multiple successive phases.

The assessment method 100 begins with a step 102 of collecting endogenous data relating to physical manifestations of at least one operator during the mission or training session and exogenous data relating to the context of the mission or training session on the platform. The endogenous data and the exogenous data may be supplied in various formats, such as for example an image format, a video, an audio signal, an electrical signal, an action or a force exerted on a controller, a continuous parameter or else a quantified parameter.

More specifically, the endogenous data collected during step 102 represent elementary events detected by the assessment method 100 and parameters in relation to observation (brief eye movement, eye path), manipulation detected on the platform, such as touch actions carried out by the pilot on their platform, on their on-board instruments or else communication with vocal parameters, lexicon used and locution.

The exogenous data are collected 102 via the platform, which supplies all of the information and parameters related to the role-playing on the platform, specifically the context, the scenario encountered by the at least one operator or the staging required by an examiner wishing to grade the skills of the at least one operator.

The detection of an action from the at least one operator takes into account the operating context, specifically the job in which the at least one operator is immersed, the professional language used, the user manual and the job manual.

By way of example, the exogenous data, which represent the context or a specific situation possibly invoking an action or reaction from at least one operator, may represent:
a flight phase, such as take-off,
flight conditions, such as the weather,
an engaged operating mode, such as autopilot mode,
the presence of any fault.

Thus, the data collection step 102 consists at least in capturing endogenous data of ocular and/or manipulative and/or communication nature, and also exogenous data.

After having collected the endogenous data coming from at least one operator and the exogenous data from the platform, the assessment method 100 initiates a step 104 of correlating the endogenous data and the exogenous data. This correlation step 104 may be interpreted as a preprocessing step applied to the raw information, namely the endogenous data and the exogenous data.

The correlation step 104 thus makes it possible to link the obtained endogenous data characterizing a physical manifestation of at least one operator in response to a recorded exogenous datum. The endogenous data are thus grouped together around one or more exogenous data. Following this correlation of the endogenous data around one or more exogenous data, the correlation step 104 makes it possible to generate observable behavior data on the basis of the observed correlations.

This correlation may be carried out temporally, that is to say that it is possible to group together endogenous data occurring following the acquisition of at least one exogenous datum, or thematically, that is to say that, on the basis of a given exogenous datum, a predefined certain number of endogenous data may be expected by the assessment method 100 so as to group together these data according to a specific theme, such as for example the verification process preceding a take-off phase of an aircraft.

Each observable behavior datum therefore comprises at least one parameter called a trigger event parameter and one parameter called an action parameter. The trigger event parameter represents the action that is at the origin of a potential reaction of the at least one operator and their conduct, represented by at least one action parameter. A trigger event may also be an exceeded time delay, as part of an ongoing procedure.

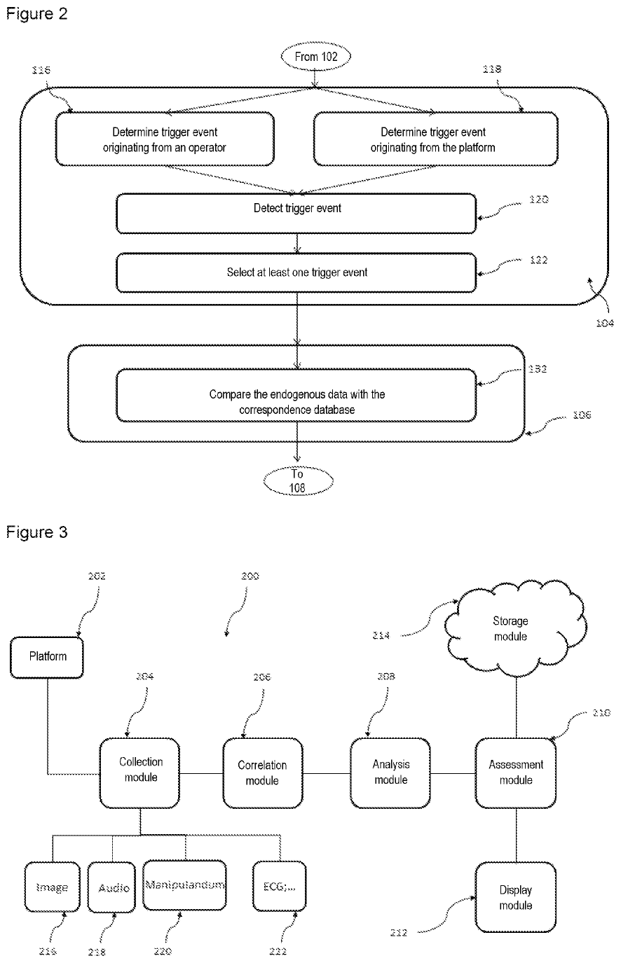

More specifically and shown in FIG. 2, the data correlation step 104 comprises a step 116 consisting in determining a trigger event originating from an operator, the trigger event originating from an operator is the occurrence of an event at the origin of an action of the at least one operator in response to this trigger event originating from an operator. The trigger parameter originating from an operator may thus be an endogenous datum, such as for example the initialization of technical dialog between the team of operators. However, it may also be contemplated, in a more generalized scenario, for the trigger event parameter to be an exogenous datum.

The data correlation step 104 then comprises a step 118 consisting in determining a trigger event originating from the platform. The trigger event originating from the platform represents the occurrence of an event at the origin of a state of the platform, and may be interpreted as an exogenous datum. This is then followed by a step 120 of detecting trigger events originating from said at least one operator or from said platform, and a step 122 of selecting at least one trigger event.

The detection 120 of a trigger event originating from an operator is based on the detection of an action from the at least one operator. The detection 120 of a trigger event originating from a platform is based on the detection of a state of the platform, such as for example a change of piloting mode, the extension or retraction of the landing gear, a fault, and on the departure from an envelope of dynamic parameters, such as for example speed, incline, attitude.

In response to the trigger event, whether it is a trigger from the at least one operator or from the platform, the assessment method 100 then captures at least one action parameter represented by an endogenous datum and presenting the physical manifestation of a reaction of the at least one operator to the trigger parameter. Grouping together a trigger parameter, represented by an exogenous datum or an endogenous datum, and at least one action parameter, represented by endogenous data, thus makes it possible, during the correlation step 104, to generate at least one observable behavior datum reflecting, according to tangible parameters, the behavior of the at least one operator upon triggering of an event.

The actions reflect the conduct of the at least one operator in the fields of observation, instrument and flight control manipulation or voice communication. By way of example, an action parameter may represent an endogenous ocular datum such as an area observed by the at least one operator, or represent an endogenous voice datum such as a phrase spoken by the at least one operator, or else the action parameter may represent an endogenous manipulation datum such as a manipulation carried out by the at least one operator.

By way of example, a trigger event parameter originating from the at least one operator may represent an endogenous ocular datum such as a specific observed area or an endogenous voice datum such as a specific detected voice message, or else an endogenous manipulation datum such as a specific detected action.

By way of example, a trigger event parameter originating from the platform may represent:
the variation in the state of the platform,
the exceedance of a threshold or the departure from an envelope for dynamic parameters of the platform,
actions carried out on the flight controls,
voice commands received from outside the cockpit or from another crew member.

The generation of observable behavior data thus tangibly reflects the production of characteristics able to be measured and detected by a time delay, a duration, a sequence or a sequencing associated with the realization of all of the elements of an observable behavior, in relation to the triggering thereof.

In step 106, the assessment method 100 comprises a step consisting in analyzing the observable behavior data in predefined analysis sequences, each predefined analysis sequence being specific to a technical and non-technical skill to be assessed, and comprising at least one trigger event parameter and one action parameter for characterizing an expected observable behavior according to a predefined situation. The analysis 106 also makes it possible to generate a measurement indicator for each observed behavior. More specifically, step 106 analyzes observable behavior data under the prism of trigger event and action parameters by comparing (step 132) the detected observable behavior data with a predefined sequence defining the expected observable behavior, each predefined sequence representing at least one physical manifestation allocated to the expected behavior. The predefined sequences are contained in a correspondence database. This correspondence database thus comprises the predefined analysis sequences presenting observable behavior data known to those skilled in the art, as well as their assigned measurable and detectable physical manifestations. Each predefined analysis sequence thus comprises at least one trigger event parameter and at least one action parameter and other endogenous and exogenous data for characterizing a flight situation and a context for at least one operator, and also their expected reaction according to the predefined situation. This analysis provides the nature of the induced action, its temporal location and also its duration or its frequency. The correspondence database also comprises a reference table containing trigger event parameters associated with each behavior to be observed.

Thus, in order to be able to analyze the behavior of at least one operator during a flight situation, the step 106 of analyzing the observable behavior data compares the detected endogenous and exogenous data, and more specifically the trigger event and action parameters, with the trigger event and action parameters and also the predefined endogenous and exogenous data. The predefined analysis sequences are specific to each technical and non-technical skill to be assessed.

The analysis of the observed behavior data that are taken into account identifies three different natures thereof, associated with the conduct of the at least one operator:
observation or ocular data,
data in relation to manipulation or manual actions on the flight controls and equipment of the operator station,
communication or voice exchange data.

These indicators for measuring observed behavior, which are determined through metrics relating to the occurrence and the sequencing of the various endogenous data related to the detected behavior, for example, may be presented, non-exhaustively, in the form of:
a time delay relative to the triggering and/or the trigger event parameter,
a minimum and maximum time delay between two occurrences of induced events of the same type,
a number of occurrences of induced events of the same type within a period of time,
an identification of an ordered succession of successive events,
a time delay between successive sequence events,
a complete sequence duration.

This generation of observed behavior indicators then makes it possible to initiate a step 108, shown in FIG. 1, consisting in assessing a behavior of at least one operator. The assessment of the behavior of the at least one operator consists in comparing the observed behavior, which is based on a set of detected behavior elements, with predefined expected reference behaviors. The conformity of an observed behavior is assessed by comparison with known prior art of defined procedures or established protocols, contained in the correspondence database.

The objectivity of the assessment of the technical and non-technical skills of an operator is thus based on the prior creation of the correspondence database between various observable behaviors and measurable physical variables in relation to these observable behaviors.

The matching consists, for each observable behavior, in determining various ways of measuring same and then developing the tools necessary for each measurement.

By way of indicative and non-exhaustive examples, various cases below are given to illustrate the matching of observable behaviors with measurable physical variables to allow behaviors to be assessed.

To assess a non-technical skill known as “leadership and teamwork”, the inventors have determined that an observable behavior related to encouraging team participation and open communication may be measured objectively by analyzing communications in order to determine the requests made by one operator to another. For the avionics field, for example, the frequency of interaction between each pilot or between a pilot and a ground operator is a measure contributing to this assessment. Other criteria, such as for example the targeting and the indentation of certain terms inducing communication as part of missions, may be established and defined according to the field of application, taking into account a vocabulary specific to this field.

Still within the context of assessing the non-technical skill of “leadership and teamwork”, the assessment of observable behavior related to the reception and/or the sending of feedback in a constructive manner may be carried out by measuring audible and visual feedback following information communicated by another operator (copilot for example), or by a crew member or by a ground operator. Non-verbal communications may therefore be analyzed to detect gestural compliance, for example, or else video analysis may be carried out to detect body movements signifying understanding, such as a nod of the head or a sign of the hand. Another measure may be the time delay between information communicated and feedback observed by the operator.

As part of the assessment of a non-technical skill of “situational awareness”, the assessment of the observable behavior related to monitoring and assessment of the general environment that could impact the operation of an aircraft may be carried out for example by measuring the percentage of time spent analyzing the external view, in flight phases in which the operator is able to afford to do so, or else may be carried out by measuring the frequency of eye movements in the direction of the available tools enabling this monitoring, or else be carried out by measuring the pilot's response time in relation to an indication related to the environment (eye movement or manipulation or else oral interaction with a crew member or a ground operator).

Those skilled in the art will understand that these observable behavior measurements may be supplemented by other measurements.

Thus, after having measured the various required parameters and data relating to an observable behavior to be analyzed, objective observable behavior references or indicators are constructed.

By way of non-exhaustive example, it is possible to measure parameters in relation to:
counting the various exceedances of machine limitations during the session;
this makes it possible to objectively measure the observable behavior in the context of the demonstration of practical and applicable knowledge of the limits and the systems and their interaction.
counting the number of requests from a pilot A to a pilot B; this makes it possible to measure the skill related to encouraging team participation and open communication.
measuring the time spent analyzing the external view in phases in which this analysis is possible; this makes it possible to objectively assess the observable behavior related to monitoring and assessing the general environment that may impact the operation of the aircraft.
measuring the time delay for the pilot's eyes to move to the indication elements in the cockpit measuring the path (speed, altitude, variometer, attitude) and comparison with an acceptable time delay threshold (varying between a few seconds and a few minutes); this allows a means for analyzing the observable behavior related to maintaining the planned flight path during the flight using automation while at the same time managing other tasks and distractions.

The measurement of the observed behaviors is therefore organized around two main steps that follow one another:
The detection of the behavior, by way of step 104 of correlating and generating observable behavior data, which identifies the elements induced or the actions induced by at least one operator following a triggering event and carried out in a defined context. This detection provides, by way of step 104, the nature of the induced action, and its temporal location by specifying the time when the action is started, when the action is ended and the duration of the action.
The measurement of the behavior, by way of step 106 of analyzing and generating observed behavior measurement indicators, which applies a metric to the realization of all of these behavior elements in relation to the triggering thereof. The observed behavior data group together a set of detected behavior elements that need to be assembled and organized and used to construct a grouping to which a metric is to be applied.

The analysis 106 and the assessment 108 of the observed behavior is tantamount to comparing the action that was produced and detected during the collection step 102 by way of the endogenous data with the actions that should be observed during a defined situation by way of the measurement of the observed behavior compared with a reference that is established by incorporating a tolerance therein. This comparison uses the correspondence database, which formalizes and codifies all of the reference elements and their tolerance, resulting from good-practice procedures from the prior art.

After having assessed the behavior of at least one operator, the assessment method 100 may initiate a step 110 consisting in assessing each technical and non-technical skill of the at least one operator on the basis of the results of the behavior assessments obtained in step 108. Step 110 thus determines a metric by combining the various assessments performed on the observable behaviors and their observed behavior measurement indicators relating to the skill in question, providing a representative succinct assessment for the entire technical or non-technical skill.

In one embodiment, the assessment method 100 comprises, after the skill assessment step 110, a step 112 of displaying the assessments of the technical and non-technical skills. Thus, in order to facilitate the reading of the assessment of the technical and non-technical skills of the at least one operator, it is possible to display one or more assessed skills according to their nature or according to a time or mission scale that makes it possible to contextualize the assessment for the instructor. This display step 112 also makes it possible to display all of the detected endogenous data correlated with the exogenous data, making it possible to precisely present the reactions of the at least one operator on the basis of the state of the real or simulated platform.

By way of example, the display step 112 may, for each skill, make it possible to display a dedicated line presenting the occurrences of the assessed and dated observable behavior data, and also a summary of the assessment of the skill.

This solution makes it possible to correlate the various skills and also to analyze the correlations with one another in terms of the various behaviors observed.

To differentiate each skill, a color code may be defined, associating each color with an assessed technical or non-technical skill.

For reasons of readability or instructor interest, each assessed skill line may or may not be displayed.

In one embodiment, the assessment method 100 may comprise a step of storing 114 the endogenous data, the exogenous data, the observable behavior data and the assessment results. This storage makes it possible to store additional data that make it possible to improve the assessment capabilities of the assessment method 100 by enriching the correspondence database for subsequent use of the assessment method 1.

The invention also proposes a device 200, shown in FIG. 3, for assessing technical and non-technical skills of at least one operator in a training situation on a real or simulated platform 200, comprising means for implementing the steps of the assessment method 100. The assessment device 200 comprises a module 204 for collecting endogenous data and exogenous data, able to implement the collection step 102, a data processing module 206 configured to correlate collected endogenous data and exogenous data and able to implement the correlation step 104, a data processing module 208 configured to analyze observable behavior data based on trigger event parameters and action parameters, and able to implement the analysis step 106, and a data processing module 210 configured to assess the behavior of said at least one operator and assess technical and non-technical skills of said at least one operator, and able to implement the steps 108 of assessing behavior and 110 of assessing each skill.

The assessment device 200 may comprise other additional modules that make it possible to implement the additional steps of the assessment method 1.

The assessment device 200 may thus comprise a display module 212 for implementing the display step 112 and a storage module 214 for implementing the storage step 114. The storage module 214 may be a physical module present in the assessment device 200 or be a digital module distributed on an Internet server, receiving and transmitting its data using an Internet network. This allows this module to have the possibility of carrying out data processing in the cloud so as to have access to a large computing capacity.

The collection module 204 also comprises at least one image sensor 216 and/or one audio sensor (for voice detection) 218 and/or one manipulandum sensor 220 and/or additional sensors 222 such as for example an electrocardiogram (ECG) physiological sensor in order to be able to collect all of the endogenous data from the at least one operator. The collection module 204 is also connected to the real or simulated platform 202 in order to have access to the exogenous data.

The invention furthermore provides a computer program product comprising code instructions for performing the data processing steps of the assessment method 100 when said program is executed on a computer.

The embodiments of the invention may be implemented by various means, for example by hardware, software, or a combination thereof.

In general, the routines executed in order to implement the embodiments of the invention, be these implemented within the context of a specific operating system or application, a component, a program, an object, a module or a sequence of instructions, or even a subset thereof, may be referred to herein as “computer program code” or simply “program code”. The program code typically comprises computer-readable instructions that reside, at various times, in various memory and storage devices in a computer and that, when they are read and executed by one or more processors in a computer, prompt the computer to perform the operations necessary to carry out the operations and/or elements specific to the various aspects of the embodiments of the invention. The computer-readable instructions of a program for performing the operations of the embodiments of the invention may be for example the assembly language, or else source code or object code written in combination with one or more programming languages.

1. A method for assessing technical and non-technical skills of at least one operator in a mission or training situation on a real or simulated platform, the assessment method comprising:
a step of collecting endogenous data relating to physical manifestations of said at least one operator during a mission or training session, and exogenous data relating to the context of said session on a real or simulated platform;
computer-implemented steps, performed by data processing modules, of:
correlating the collected data in order to link endogenous data to exogenous data;
detecting observable behavior data using the correlated data, an observable behavior datum comprising at least one parameter called a trigger event parameter and one parameter called an action parameter;
analyzing the observable behavior data in predefined analysis sequences, each predefined analysis sequence being specific to a technical and non-technical skill to be assessed, and comprising at least one trigger event parameter and one action parameter characterizing an expected observable behavior according to a predefined situation, the analysis generating a measurement indicator for each observed behavior;
assessing the behaviors of said at least one operator, said assessment consisting in comparing an observed behavior with an expected predefined reference behavior; and
assessing each technical and non-technical skill of said at least one operator on the basis of the results of the behavior assessments.

2. The method for assessing technical and non-technical skills as claimed in claim 1, wherein the data collection step consists at least in capturing endogenous data of observational and/or manipulative and/or communication nature.

3. The method for assessing technical and non-technical skills as claimed in claim 1, wherein the data correlation step consists in temporally grouping together endogenous data occurring following the acquisition of at least one exogenous datum or in grouping them together thematically on the basis of a given exogenous datum.

4. The method for assessing technical and non-technical skills as claimed in claim 1, wherein the step of detecting observable behavior data comprises a step consisting in determining a trigger event originating from said at least one operator, said trigger event being notably the occurrence of an event at the origin of an action of said at least one operator or an exceeded time delay.

5. The method for assessing technical and non-technical skills as claimed in claim 1, wherein the step of detecting observable behavior data comprises a step consisting in determining a trigger event originating from the real or simulated platform, said trigger event being the occurrence of an event at the origin of a change in state of the platform.

6. The method for assessing technical and non-technical skills as claimed in claim 4, wherein the step consisting in determining a trigger event comprises a step of detecting trigger events originating from said at least one operator or from said platform, and a step of selecting at least one trigger event.

7. The method for assessing technical and non-technical skills as claimed in claim 1, wherein the analysis step comprises a step of comparing detected observable behavior data with a predefined sequence defining the expected behavior, each predefined sequence representing at least one physical manifestation allocated to the expected behavior, the predefined sequences being contained in a correspondence database.

8. The method for assessing technical and non-technical skills as claimed in claim 1, additionally comprising, after the skill assessment step, a step of displaying the assessments of the technical and non-technical skills.

9. The method for assessing technical and non-technical skills as claimed in claim 1, comprising a step of storing the endogenous data, the exogenous data, the observable behavior data and the assessment results.

10. A device for assessing technical and non-technical skills of at least one operator in a training situation on a real or simulated platform, the assessment device comprising means for implementing the steps of the assessment method as claimed in claim 1.

11. A flight simulator comprising an assessment device as claimed in claim 10.

12. A computer program product, said computer program comprising code instructions for performing the steps of the method as claimed in claim 1 when said program is executed on a computer.
